(19) United States
(12) Patent Application Publication
(10) Pub. No.: US 2016/0028486 A1
(43) Pub. Date: Jan. 28, 2016

(54) Modular Passive Optical Network Recessed Wall Mounted Optical Network Terminal System

(71) Applicant: Tellabs Bedford, Inc., Naperville, IL (US)

(72) Inventors: Michael J. Wilson, Elkridge, MD (US); Thomas C. Ruvarac, Naperville, IL (US)

(21) Appl. No.: 14/341,132

(22) Filed: Jul. 25, 2014

(51) Int. Cl. H04B 10/40

(52) U.S. Cl. CPC H04B 10/40

(57) ABSTRACT

An optical network terminal (ONT) includes an ONT base bracket (OBB) configured to receive an optical medium and a power-conveying medium. The ONT also includes a modular ONT unit (MOU), which deploys within and detachably couples to the base bracket. The MOU communicates optical signals associated with the optical medium and receives power from the power medium. The MOU also communicates external format signals associated with an external environment. The MOU converts the optical signals to the external format signals, and converts the external format signals to the optical signals. Two or more OBBs may be combined to form the infrastructure for an optical local area network (OLAN). Each of the OBBs may be fixedly attached to a corresponding structural fixture, where the OBB terminates at least one optical fiber medium and at least one power-conveying medium.

### BACKGROUND OF THE INVENTION

Optical Local Area Networks (OLANs) are appealing because OLAN network architectures typically require fewer network components as compared to wired network architectures. An Optical Network Terminal (ONT), mounted for example in an office wall, may provide a user access point into the OLAN. Since the ONT is a termination point for an optical cable, replacing or upgrading an ONT can be a high-maintenance operation.

### SUMMARY OF THE INVENTION

In one aspect, the described embodiments are an optical network terminal (ONT) including an ONT base bracket (OBB) configured to receive an optical medium and a power-conveying medium. The ONT further includes a modular ONT unit (MOU) configured to deploy within, and detachably couple to, the base bracket. The MOU is further configured to communicate optical signals associated with the optical medium, and to receive power from the power medium. The MOU is also configured to communicate external format signals associated with an external environment. The MOU is further configured to convert the optical signals to the external format signals, and to convert the external format signal to the optical signals.

In another aspect, the described embodiments are an optical network terminal base bracket (OBB) that includes a housing configured to facilitate fixed attachment to a structural fixture. The housing includes a recess configured to receive a modular optical network terminal unit (MOU). The OBB also includes one or more optical connections, each configured to couple to the optical medium, and a power connection configured to couple to the power-conveying medium. The OBB further includes a first connector component disposed within the recess. The first connector component is configured to convey optical signals from the optical medium and power from the power-conveying medium to a second connector component that is associated with the MOU. The first and second connector components are configured to removably couple to one another, which allows the MOU to be quickly and easily removed from the OBB without a substantial maintenance procedure and likewise swap in another MOU to provide an upgrade or different functionality.

In another aspect, the described embodiments are an optical local area network (OLAN) that includes an optical network terminal base bracket (OBB) configured to facilitate fixed attachment to a structural fixture. The base bracket is configured to accept optical media and power-conveying media, and is configured to detachably couple to a modular optical network terminal unit (MOU). The OLAN includes two or more of the OBBs, each being fixedly attached to a corresponding structural fixture. Each of the two or more OBBs terminates at least one optical fiber medium and at least one power-conveying medium.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 illustrates an example of an optical network connection 100 between an office 102 and a network closet that includes an optical network terminal according to an embodiment of the present invention.

FIG. 2 illustrates a side view of one embodiment of an optical network terminal (ONT) that includes an ONT Base Bracket (OBB) according to the described embodiments.

FIG. 3 illustrates a front view of the OBB shown in FIG. 2.

FIG. 4 illustrates a back view of the OBB shown in FIG. 2.

FIG. 5A shows a block diagram view of an example signal flow through an ONT according to the described embodiments.

FIG. 5B shows the signal flow of FIG. 5A for a specific example application.

FIG. 6A illustrates an example of an Ethernet interface consistent with the ONT of FIG. 5B.

FIG. 6B shows an example Modular ONT unit (MOU) external interface for an IP camera application.

FIG. 6C shows an example MOU external interface for an audio/visual (AN) touch screen application.

FIG. 6D shows an example MOU external interface for a High Definition (HD) set top box application.

FIG. 6E shows an example MOU external interface for an IEEE 802.11 access point application.

FIG. 7 shows an example ONT block diagram according to the described embodiments.

### DETAILED DESCRIPTION OF THE INVENTION

A description of example embodiments of the invention follows.

An Optical Network Terminal (ONT), for example as described in U.S. Patent Publication No. 2014/0072264 (U.S. patent application Ser. No. 13/608,156, filed Sep. 10, 2012), which is incorporated by reference herein in its entirety, provides an endpoint for an Optical Local Area Network (OLAN). A modular approach to an in-wall ONT according to described embodiments enables a straightforward ONT upgrade that can be performed in the field and does not require complete ONT replacement.

The described modular approach does not require removal and replacement of the in-wall optical fiber to accomplish an ONT upgrade, thereby eliminating the potential of a technician damaging the in-wall optical fiber or of a poorly seated optical fiber connector. Because the ONT of the described embodiments may be an in-wall fixture, the described ONT may be more aesthetically pleasing compared to an ONT that is more visible to an end user.

Further, the modular in-wall ONT solution provides greater flexibility by enabling the option for third-party product development.

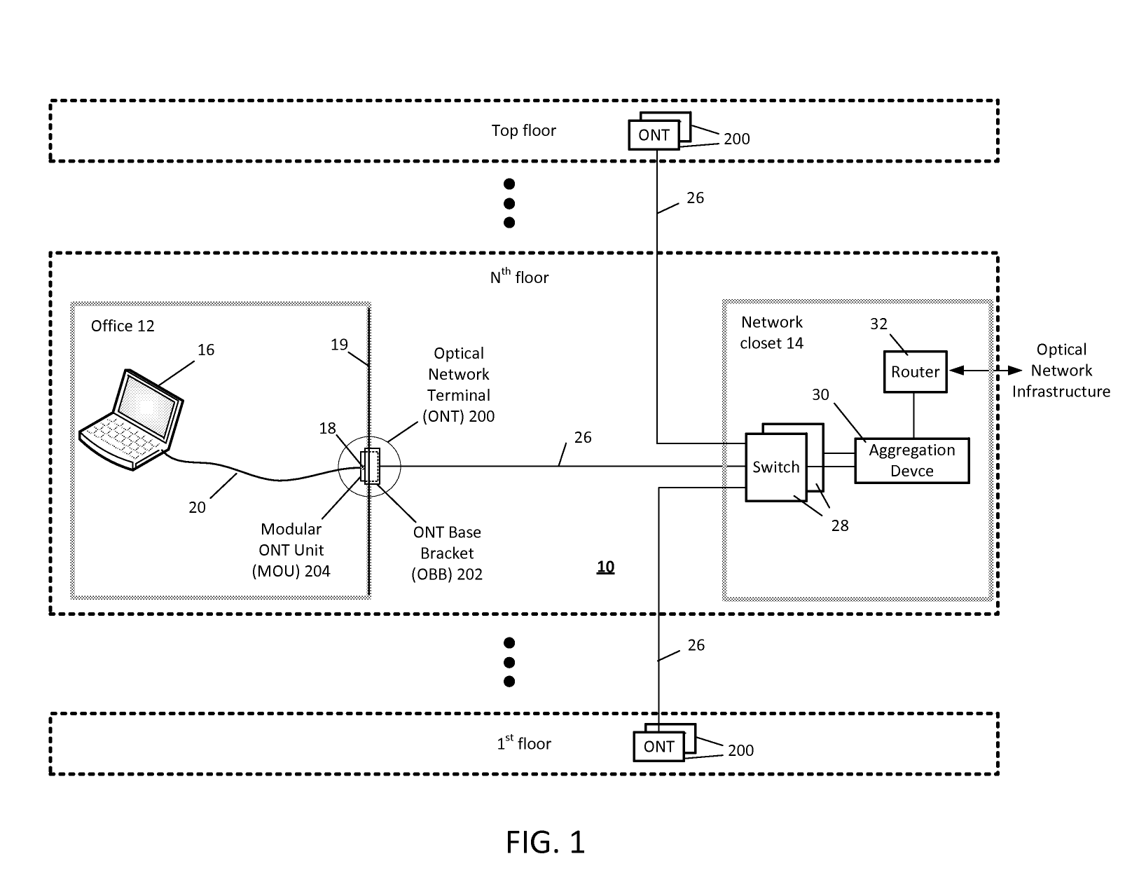

FIG. 1 illustrates an example of an optical network 10 between an office 12 and a network closet 14. Connection particulars are presented in FIG. 1 for one ONT 200 according to the described embodiments, while summary connections are shown for ONTs on other floors of the building. For some embodiments, the ONT 200 includes an ONT base bracket (OBB) 202 and a modular ONT unit (MOU) 204.

The OBB 202 may be a permanent portion of the ONT 200, in that the OBB 202 may be attached to a permanent mount. The mount may be a wall 19, as shown in FIG. 1, although the mount could be any structural fixture, such as a wall stud, ceiling panel or ceiling joist. In other embodiments, the mount may be a non-structural fixture, such as in a recess within a conference room table.

The MOU 204, on the other hand, may be a less permanent portion of the ONT 200. As will be described in more detail below, the MOU 204 gives an ONT 200 its particular character. For example, the example MOU 204 shown in FIG. 1 provides a network terminal connection 18 for use by a computer. In practice, the MOU 204 can be swapped with different MOU that provides another function (e.g., a high definition (HD) set top box) if that other function is needed, without performing the maintenance necessary to replace an entire ONT.

In the example of FIG. 1, computer 16 connects to the network 10 at a network terminal connector 18 through a cable 20. The network terminal connector 18 is hosted by the MOU 204 portion of the ONT 200, which is mounted within the office 12.

OBB portion 202 of the ONT 200 is coupled to fiber optic cables 26 within the building walls. The fiber cables 26 may include one or more individual optical fibers, and connect the network terminal connector 108 to a network switch 28 in a network closet 14. The network switches 28 also receive optical cables 26 from ONTs on other floors. The network switches 28 may be aggregated by an aggregation device 30 and provided to a router 32.

When deploying an Optical LAN (OLAN), prior art ONTs may be rack mounted, desktop mounted, wall mounted, cubicle raceway mounted, or in-wall (i.e., embedded) deployed. Wall mount ONTs are viewed as too large and obtrusive in many office environments—they generally either require too much wall space, are too deep to fit into a standard electrical wiring box, or both.

In addition, prior art ONTs (rack mount, desktop mount, wall mount, cubicle raceway mount and in-wall ONTs) are generally of fixed configuration, so that upgrading an existing ONT requires total replacement of the ONT. Total replacement of in-wall ONTs is of particular concern as it requires a highly-skilled, highly-paid technician to remove the ONT from the wall, while taking care to keep the optical fiber clean, and to ensure that the optical fiber connector is reconnected and seated properly before physically replacing the in-wall ONT.

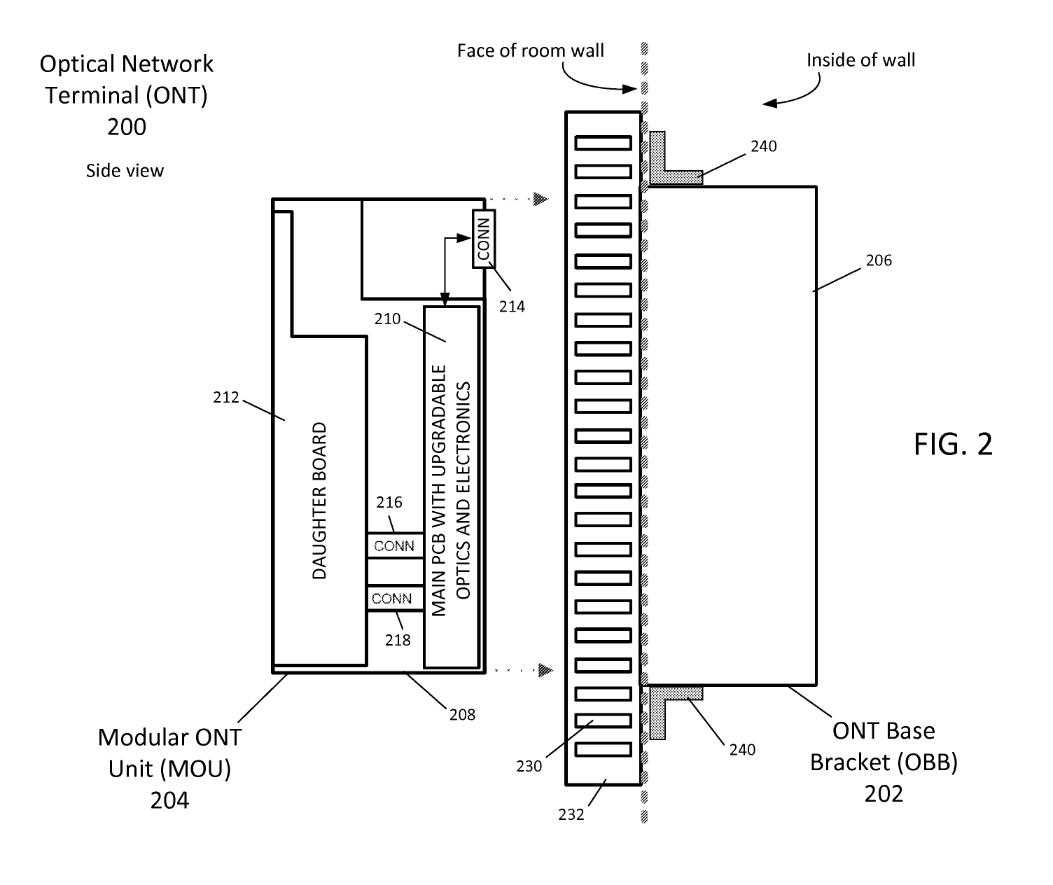

FIG. 2 illustrates a side view of an optical network terminal (ONT) 200 according to an embodiment of the present invention. The ONT 200 includes an ONT Base Bracket (OBB) 202 and a Modular ONT Unit (MOU) 204.

In one embodiment, the OBB 202 includes a housing 206 constructed and arranged to be fixed to a structural component of, for example, a wall or ceiling. In some embodiments, the OBB 202 may be constructed to accommodate mounting to a rack, desktop, wall, cubicle raceway, or in-wall (i.e., embedded), among other such fixtures. The OBB housing 206 may have mounting hardware (not shown) attached to it, or the OBB housing 206 may have mounting hardware integrated into the walls of the OBB housing 206. The OBB housing 206 may have holes in its sides or back to be used in conjunction with fixing hardware (e.g., screws or nails or other such hardware) to fixedly attach the housing 206 to a structural component of the wall or ceiling, such as a stud or joist. In one embodiment, the OBB 202 embeds within a wall of an office or other room within a building. The OBB 202 may mount, for example, within a standard electrical back-box or “mud-ring,” or other such fixtures known in the art. The OBB further includes air vents 230 associated with an air vent assembly 232.

In some embodiments, the OBB 202 may be configured to be fastened directly to a wall panel (e.g., by clamping) without the need for a wall stud or other such structural component that supports the wall panel. To implement such an embodiment, example brackets 240 may be included with, and attached to, the OBB 202 as shown in FIG. 2. Such brackets 240 may work in conjunction with the air vent assembly 232 to clamp the wall between the bracket 240 and the air vent assembly 232. In some embodiments, the outer structure with which the brackets 240 cooperate to claim the wall may be a faceplate assembly (not shown), which may be thinner than the air vent assembly 232, so that the resulting OBB 202 installation is substantially flush with the outer surface of the wall. In such installations, the faceplate (not shown) of the faceplate assembly may include air venting features, as is shown for the air vent assembly 232.

The MOU 204 may include a housing 208, a main PCB 210, and a daughter board 212, connected to one another through connectors 216, 218. The MOU 204 may connect to the OBB 202 through a common connector 214. As previously described, the MOU 204 is a modular device that can be inserted into and removed from the OBB 202. The MOU 204 receives optical and electrical signals from the OBB 202 through the detachable common connector 214 (i.e., a connector that can be attached/detached/re-attached to a mating connector with little or no specialized maintenance), and adapts those signals to present an external interface.

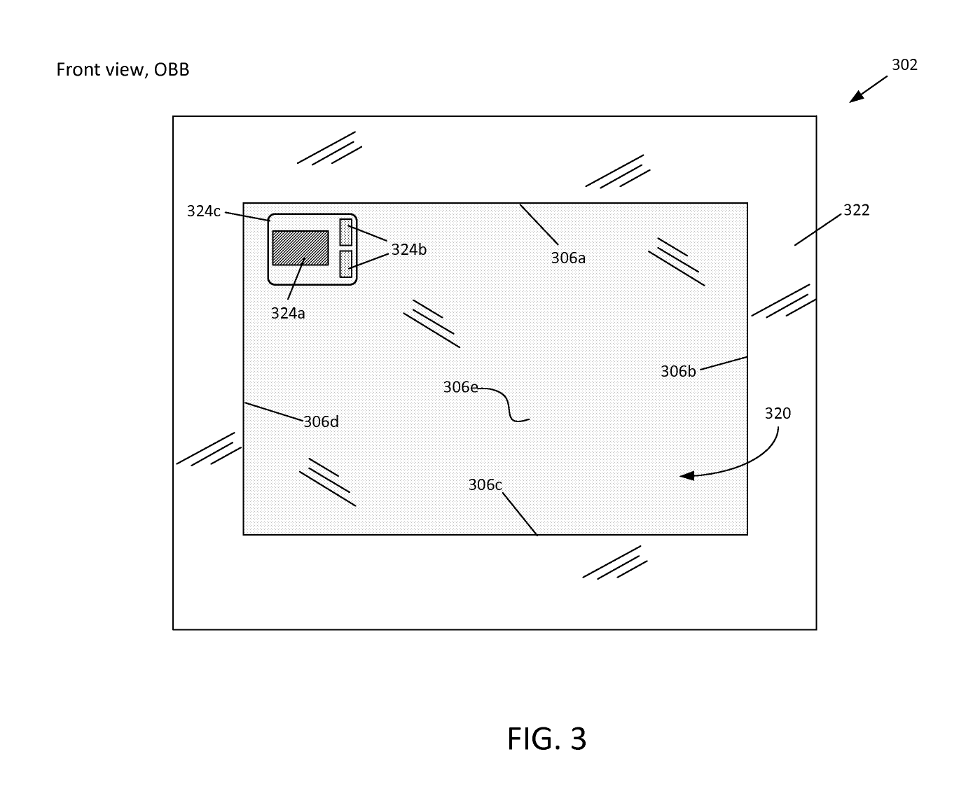

The MOU 204 may include an MOU housing 208, a main printed circuit board (PCB) 210 and a daughter board 212. The MOU housing 208 may include one or more connectors 214, which correspond to the power connector 324a and the optical connector 324b that are shown in FIG. 3 (described in more detail below).

The one or more common connectors 214 mate with corresponding connectors (324a, 324b shown in FIG. 3) on the OBB 202 to form a detachable (i.e., disconnectable) optical and electrical connection to the OBB 202. While these connectors provide electrical and optical interfaces between the OBB 202 and the MOU 204, they may also provide a mechanical interface for securing the MOU 204 to the OBB 202 and for aligning the MOU 204 and the OBB 202 connectors to ensure a proper electrical and optical interface. Alternatively, the MOU 204 and OBB 202 may include hardware that secures the MOU 204 and OBB 202 together and provides mechanical alignment for mating the associated connectors.

The one or more common connectors 214 couple optical and electrical signals to the main PCB 210. In some embodiments, the one or more common connectors 214 are coupled directly to the main PCB 210. In other embodiments, the one or more connectors 214 are optically and electrically coupled to the main PCB 210 through appropriate media (e.g., electrical conductors and fiber optics), as depicted in FIG. 2.

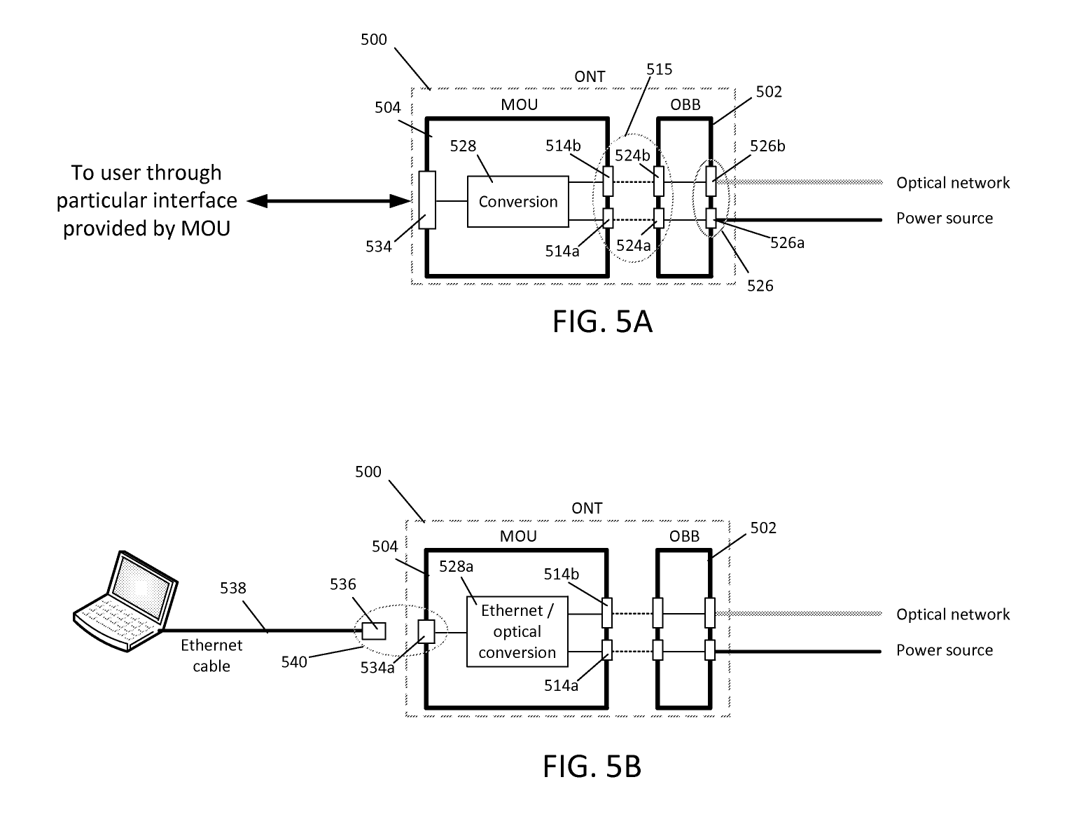

In the example embodiments, the main PCB 210 provides a detachable optical connector 216 and detachable electrical connector 218 for coupling to corresponding connectors on the daughterboard 212. The detachable connectors 216, 218 allow for replacement of the daughterboard without substantial maintenance operations or rework time. In the example embodiments, the daughterboard provides a large portion of the unique aspects of an MOU 204. For example, with the MOU 204 shown in FIG. 5B, the daughterboard provides the components necessary to convert signals between an optical format and an Ethernet format. The daughterboard 212 may include one or more electronic chipsets, e.g., Application Specific Integrated Circuit (ASIC) devices, optical transponders and related optics to provide the baseline Optical Network Terminal (ONT) functionality.

In the example embodiments, the main PCB 210 includes electrical components, optical components and associated electrical conductors and optics that provide electrical and optical functionality necessary regardless of the MOU external interface type. The optics and electronics on the main PCB 210 are replaceable to allow an upgrade in the event the optics and/or electronics of the optical network evolve (e.g., the optical wavelengths change or additional wavelengths are to be used).

In other embodiments, the distribution of components is different from that described herein for the example embodiments, i.e., in other embodiments the components that provide unique MOU functionality may be located in the main PCB 210 and/or the daughterboard 212.

In one embodiment, the MOU 204 daughterboard may include a device socket arrangement to facilitate the use of current ITU G.984.x compliant Gigabit Passive Optical Network (GPON) chipsets, ITU G.987.x compliant XG-PON1 and XG-PON2 chipsets, and future WDM-PON chipsets, without replacing the entire MOU or MOU daughterboard.

The MOUs PCB-to-daughterboard interface facilitates integration by third party A/V controller manufacturers and provides native Internet Protocol (IP) communication with bandwidth shaping, Quality of Service/Class of Service (QoS/CoS), virtual local area network (VLAN) tagging, differential services code point (DSCP), access control lists, and 802.3ae media access control security (MACSEC) hardware encryption capabilities.

In general, the MOU 204 provides an adapter function between the optical media provided by the OBB 202 and any of a variety of external interfaces. One example embodiment, described in detail in FIG. 5B below, presents an Ethernet port as the external interface. The MOU 204 in this example provides an adapter function between the optical media provided by the OBB 202 and the Ethernet port.

The OBB 202 according to the described embodiments may include heat sinks (not shown, but deployed within the OBB) and air venting 230 associated with the external portion 232 of the MOU 204. The heat sinks are constructed and arranged to convey thermal energy from active, heat producing components in the ONT 200 and dissipate the thermal energy by convention through the air vents 230.

It should be understood that the MOU 204 can be removed from the OBB 202 through simple mechanical release(s) (not shown) and entirely replaced for simple upgrade of active (or passive) MOU components, which thus upgrades the ONT 200. Such MOU replacement may also be for the purpose of a functionality change as opposed to an upgrade of a particular functionality. Notably, because optical cabling between the OBB 202 and network devices in a network closet (e.g., as shown in FIG. 1) are not required to be handled, a customer or entry level craftsperson can perform the ONT upgrade or functionality change from within an office without any special tools or training In other words, the ONT can be upgraded or changed at a replaceable modular (MOU) level.

FIG. 3 illustrates a front view of an OBB 302, which includes a recess or cavity 320 formed by four side housing walls 306a, 306b, 306c and 306d, and a back housing wall 306e. Surrounding the recess 320 is a front plate 322, which may include channels and associated exhaust ports for ventilating and/or cooling the OBB 302.

The back wall 306e hosts one or more connectors for conveying electrical and optical signals. The example in FIG. 3 shows a power connector 324a and two optical connectors 324b at the back wall 306e, although the connectors could alternatively be associated with one or more of the side walls or both the back wall and one or more of the side walls. Further, the power and optical connectors 324a, 324b may be located in different positions on the back wall 306e compared to the example shown in FIG. 3. The one or more connectors may include a single connector 324c, which integrates two or more of the electrical, optical and other signals.

The optical connectors 324b and the power connector 324a are constructed and arranged to be repeatedly coupled to and decoupled from corresponding connectors on the MOU 204, as is described in more detail elsewhere herein.

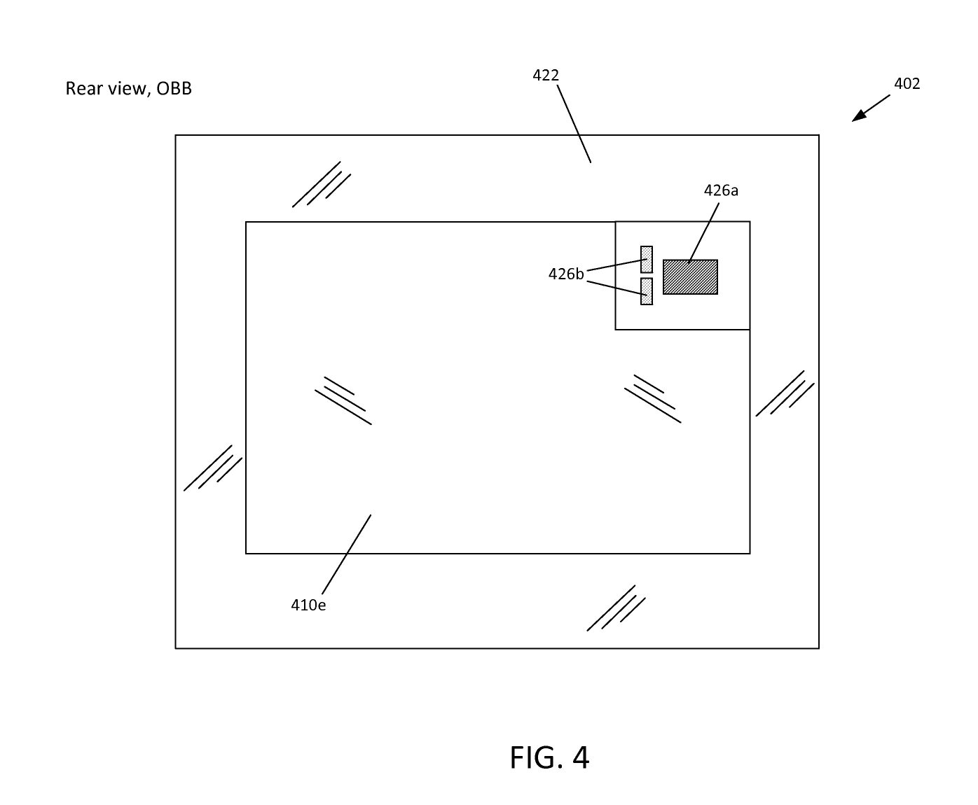

FIG. 4 shows a rear view of the OBB 402. This view shows the rear-facing portion 402 of the front plate, and the rear face of the back wall 410e. Also shown in this view are optical connection 426b that corresponds to the optical connectors 324b shown in FIG. 3, and a power connection 426a that corresponds to the power connector 324a in FIG. 3. The optical connection 426b is optically coupled to the optical connectors 324b and the power terminal 426a is electrically coupled to the power connector 324a.

In one embodiment, the optical connection 426b may be physically coupled to the optical connector 324b to form a single, integrated unit, so that the optical connection 426b and the optical connector 324b provide a feed-through of the optical signal being conveyed. Similarly, the power connection 426a may be physically coupled to the power connector 324a, providing a feed through of the associated power inputs. In other embodiments, the optical connection 426b and the optical connectors 324b may be physically separate and only optically coupled. Similarly, the power connection 426a and the power connector 324b may be physically separate and only electrically coupled.

The OBB may include one or more of several different powering arrangements. In some embodiments, the OBB includes a hardwired AC-feed as described in the examples herein. In other embodiments, the OBB further includes an integrated battery pack (for example, a Lithium Ion pack or other type of battery known in the art) to power the ONT for a period of time during a loss of commercial AC power through the hardwired input. The battery pack may provide, for example, a minimum of 15 minutes of run-time for the ONT and up to 25.6 W of consumed PoE (power over Ethernet) power. In some embodiments, the battery pack provides 8 hours of backup power. In other embodiments, the OBB includes a direct wired power feed from a centralized ONT power distribution unit. The OBB may include an indicator (e.g., an LED) that informs an observer that the OBB is actively receiving power from a power source. The indicator may include a distinction between different power sources (e.g., one indication when fixed power is available, and a different indication when the OBB is operating on battery power.

The OBB may be deployed without an associated MOU, in which case the OBB may include a blank plate to cover the recess normally occupied by an MOU. Such a deployment may be used in situations where optical network infrastructure is to be installed but without active services, which may be installed at a later time. An OBB deployed in this way may provide a cost-effective technique for deploying remote powering and optical fiber termination for an optical network, thereby creating a flexible, upgradeable network environment. An OBB deployed in this way may also serve as a “permanent link” test point within the optical distribution network, allowing for fiber to be tested and results measured as is the case within nearly all enterprise installations.

In some embodiments, the OBB may contain no digital logic components, although in other embodiments the OBB may contain electrically active digital logic components. The OBB of the described embodiments may be constructed and arranged so that a layer-1 installation contractor or electrical contractor can easily install the OBB with no prior OLAN knowledge or formal training The OBB, therefore, presents a clear delineation of where services are left for the end customer/integrator to provide active OLAN components.

FIG. 5A shows a block diagram view of an example signal flow through the ONT 500 (the OBB 502 and the MOU 504). In this embodiment, a permanent coupling 526 is at the OBB 502, permanently connecting the optical connection (or connections) 526b to an optical network and the power connection (or connections) 526a to a power source. A detachable interface 515 is between the OBB 502 and the MOU 504, coupling the optical connector component 524b at the OBB 502 and a mating optical connector component 514b at the MOU 504, and coupling the power connector component 524a at the OBB 502 and a mating power connector component 514a at the MOU 504. The optical connector components 524b and 514b include alignment features to facilitate mechanical mating of the one or more optical fibers in the coupling between the OBB 502 and the MOU 504. In some embodiments, the connector components 524a and 524b on the OBB may be a single connector or multiple connectors. Similarly, the corresponding connector components 514a and 514b at the MOU may be a single connector or multiple connectors.

These optical and power couplings may be “removable couplings” (also referred to as “removably coupled”), which means that the couplings can be quickly and easily engaged and disengaged without a significant maintenance action (i.e., without specialized tools or a specially-skilled technician). The detachable connections are shown conceptually in FIG. 5A with dotted lines. Although in this example the optical connectors and the power connector are distinct connectors, some embodiments may include both types of interfaces integrated into a single connector.

A conversion block 528 (also referred as conversion module or conversion device) receives the optical and electrical signals from the MOU connectors 514a and 514b. This conversion block 528 is also coupled to an external interface 534 on the MOU 504. The conversion block 528 performs translation functions and services necessary to convert optically encoded data from the optical network into whatever format and medium is supported by the external interface 534, and from the desired format back to optical data. FIG. 5B illustrates a specific example to help further explain the conversion block 528.

FIG. 5B illustrates an ONT 500, according to the described embodiments, that converts optically encoded data from an optical network into data suitable for an Ethernet connection, similar to the connection between a computer and local network depicted in FIG. 1. The conversion block 528a provides the translation functions and services necessary convert optically encoded data from the optical network into a format suitable for communication on an Ethernet connection, and back again from Ethernet format to optical format. The external interface 534a presents a standard Ethernet port, such as a T568B port for a Category 5 connector 536 and cable 538 or other such Ethernet interface known in the art. The interface 534a and connector 536 form a detachable connection 540. The ONT 500 of FIG. 5B thus facilitates an Ethernet interface that benefits from many of the advantages of an optical network.

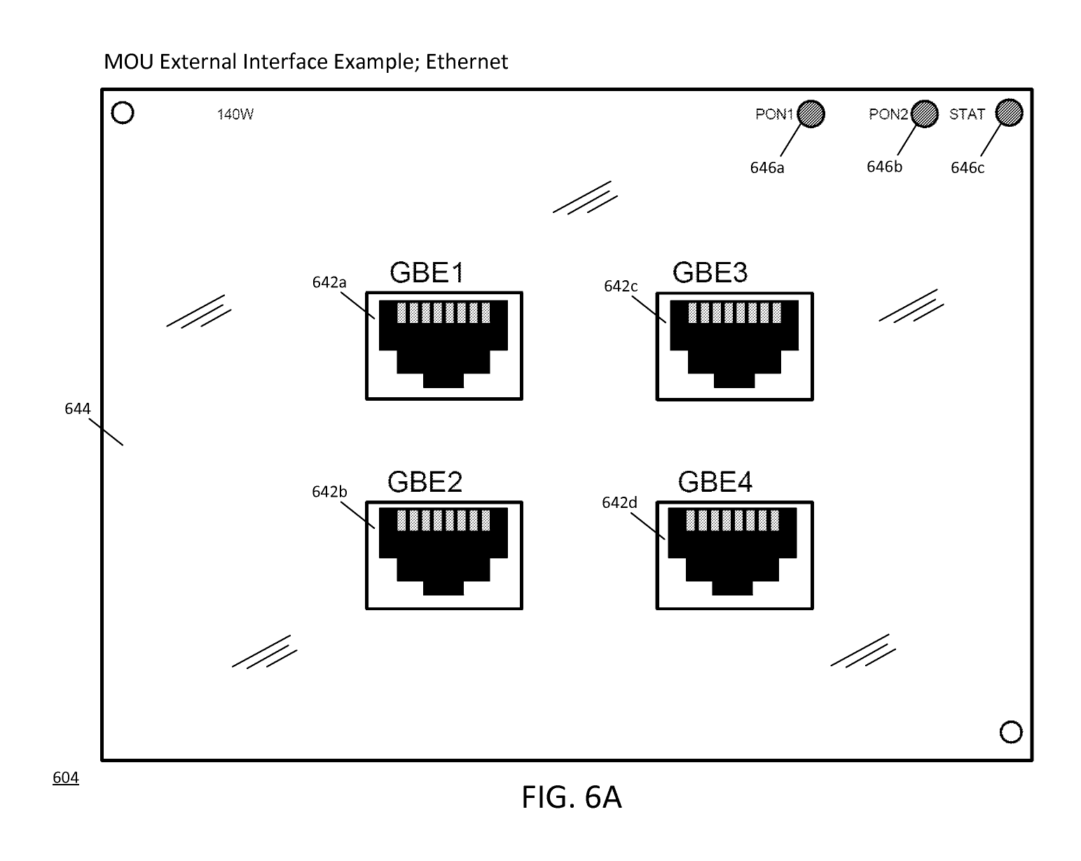

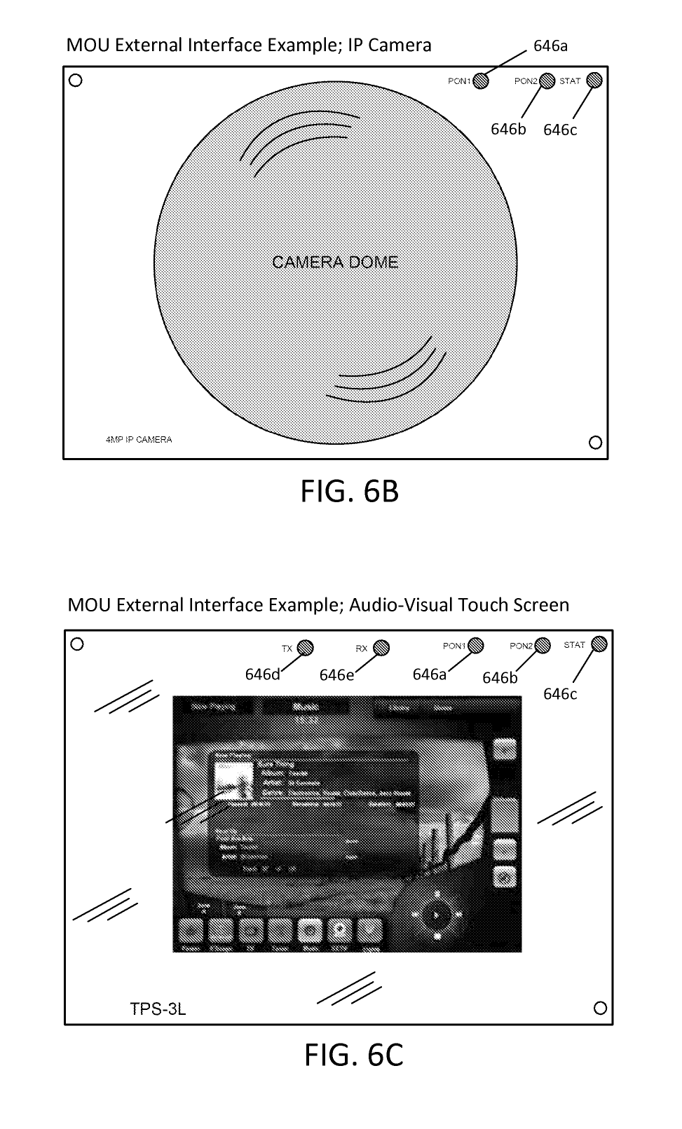

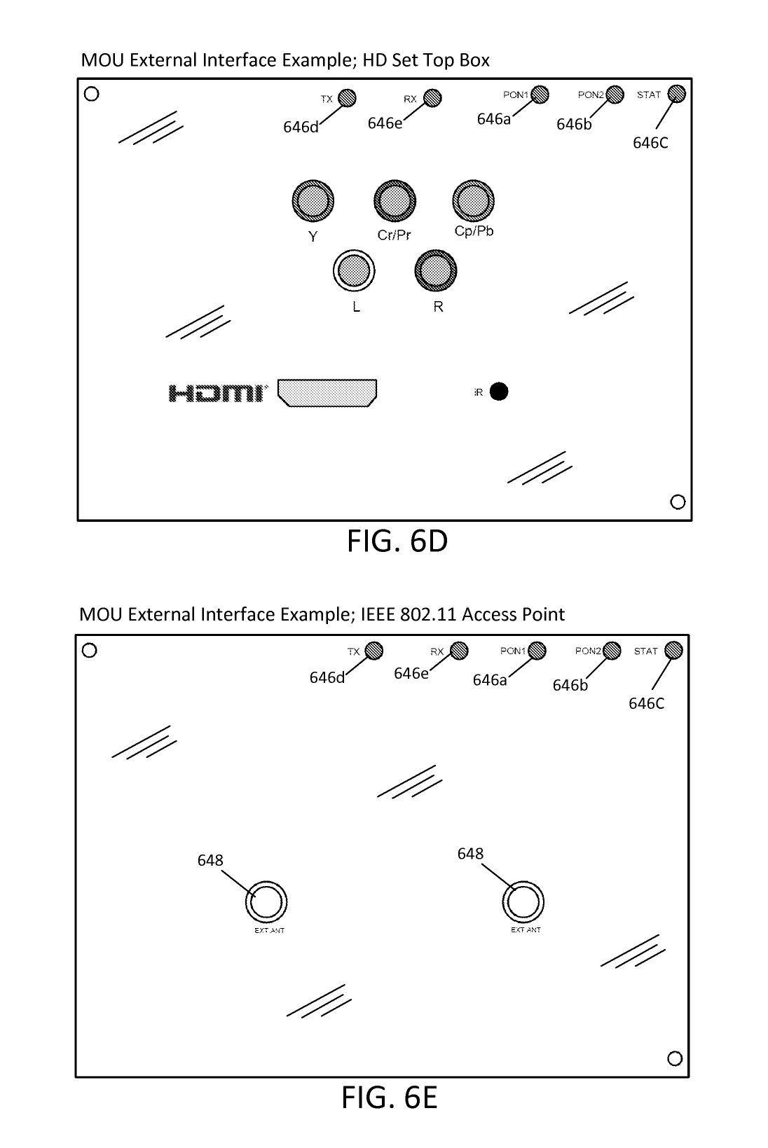

FIG. 6A illustrates an example of an Ethernet interface consistent with the ONT of FIG. 5B. The MOU 604 in FIG. 6A includes four Ethernet input ports, GBE1, GBE2, GBE3 and GBE4, labeled 642a, 642b, 642c and 642d, respectively, disposed on the external face 644 of the MOU 604. The MOU external face 644 further includes indicators 646a, 646b and 646c. In this example, indicators 642a and 642b are light emitting diodes (LEDs) that provide a visual indication of the status of two available passive optical networks, PON1 and PON2. The third status indicator 646c shown on the MOU external face 644 indicates the overall status of the ONT 600. Other indicators may also be included, and those indicators may be other types of visual indicators (e.g., incandescent bulbs) or they may provide other types of indications (e.g., sound or WiFi signals instead of light).

The modularity of the MOU enables a relatively quick and easy change from one external interface to another. FIGS. 6B through 6E, described below, illustrate some example external interfaces (each on the external face of an OBB) that may be presented with the described embodiments. These examples are not intended to limit the described embodiments in any way, and it should be understood that an MOU constructed and arranged according the described embodiments can provide any of a wide variety of external interfaces known in the art.

FIG. 6B shows an MOU that provides an IP-based digital video camera as an external interface. Such an MOU may be used as a permanent installation, or where a temporary video feed is needed. In the case of a temporary installation, the video MOU of FIG. 6B may be temporarily installed in an OBB fixture that is normally used for another application (e.g., an Ethernet port).

FIG. 6C shows an MOU that provides an audio-visual (A/V) touch screen as an external interface. Such an A/V touch screen may be used as, for example, a control center for various functions within the room (i.e., room lighting, control of window blinds, control of audio/video conference services) or as a telecommunications port for communicating with others in the building or at remote locations. This example MOU includes two additional status indicators 646d and 646e, which indicate status of the transmitter and receiver, respectively, of the A/V system.

FIG. 6D shows an MOU that provides the interfaces and functionality of a high definition set top box. In addition to an HDMI port, the MOU of FIG. 6D provides a component video interface and left/right audio connections, along with an infrared (IR) port for controller input.

FIG. 6E shows an MOU that provides a WiFi interface, which may include IEEE 802.11B/G/N/AC/AD capable wireless access points (WAPs) or any other similar local area wireless standard known in the art. In this example, the MOU presents a pair of external coaxial antenna interfaces 648 on the MOUs faceplate. In other embodiments, the MOU may provide internal antennae so that the MOU provides one or more WAPs without any external hardware or external connections.

It will be apparent that one or more embodiments described herein may be implemented in many different forms of software and hardware. Software code and/or specialized hardware used to implement embodiments described herein is not limiting of the embodiments of the invention described herein. Thus, the operation and behavior of embodiments are described without reference to specific software code and/or specialized hardware—it being understood that one would be able to design software and/or hardware to implement the embodiments based on the description herein.

Further, certain embodiments of the example embodiments described herein may be implemented as logic that performs one or more functions. This logic may be hardware-based, software-based, or a combination of hardware-based and software-based. Some or all of the logic may be stored on one or more tangible, non-transitory, computer-readable storage media and may include computer-executable instructions that may be executed by a controller or processor. The computer-executable instructions may include instructions that implement one or more embodiments of the invention. The tangible, non-transitory, computer-readable storage media may be volatile or non-volatile and may include, for example, flash memories, dynamic memories, removable disks, and non-removable disks.

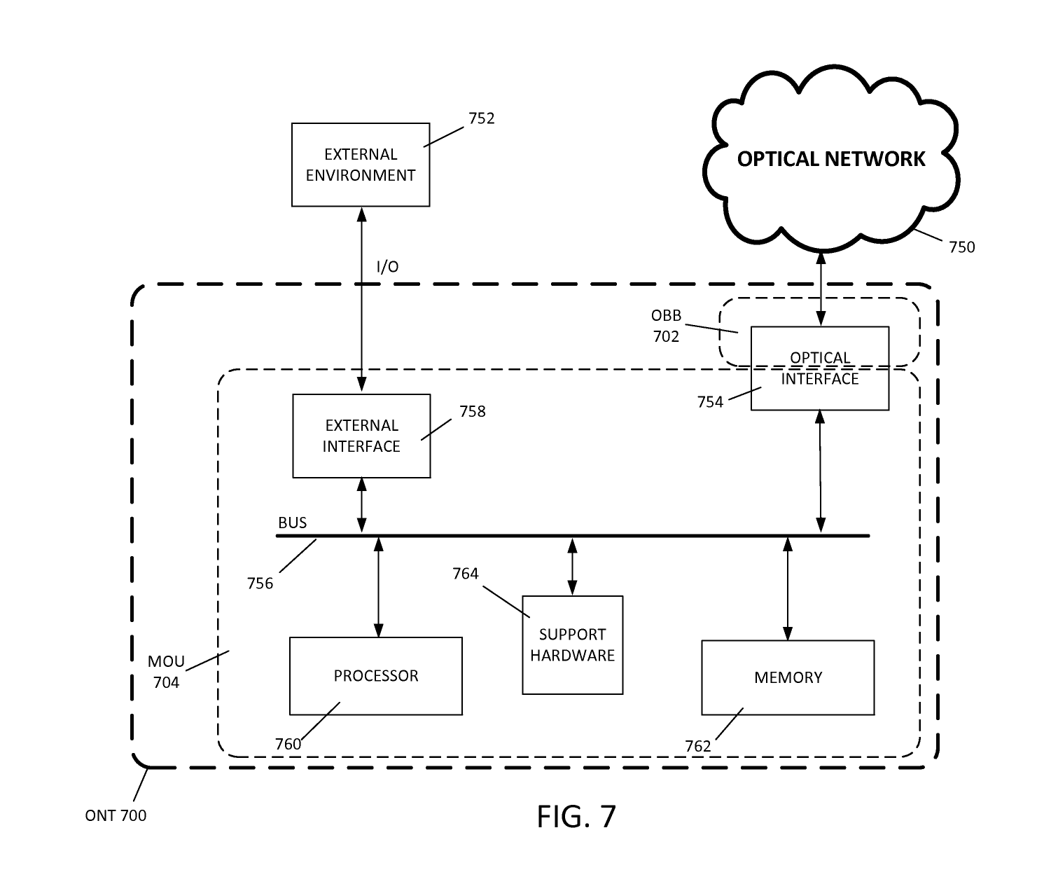

FIG. 7 illustrates an example ONT 700, OBB 702, and MOU 704 according to the described embodiments. The ONT 700 communicates with an optical network 750 and provides an interface to an external environment 752.

The optical interface 754 provides a transition between the optical network 750 and an MOU bus 756 (the optical interface 754 receives optical information from the optical network 750, converts the optical information into electrical signals, and provides the electrical signals to the MOU bus 756). As shown, the optical interface 754 is distributed across both the OBB 702 and the MOU 704.

The external interface 758 provides a transition between the external environment 752 and the bus 756. The term “external environment” may refer to users of the ONT, such as the computer user for the example shown in FIG. 6A, or the A/V touch screen user for the example shown in FIG. 6C, or the WiFi stations seeking to connect to the access point example of FIG. 6E.

In this example embodiment, a processor 760, a memory 762, and support hardware 764 cooperate to perform the functionality necessary to convey information between the optical interface 754 and the external interface 758.

The components depicted in FIG. 7 may include general-purpose electrical and optical components, or they may include application specific integrated circuits (ASICs) or application specific optical components, or a combination of general-purpose components and application specific components.

While this invention has been particularly shown and described with references to example embodiments thereof, it will be understood by those skilled in the art that various changes in form and details may be made therein without departing from the scope of the invention encompassed by the appended claims.

What is claimed is:

1. An optical network terminal (ONT), comprising:
an ONT base bracket (OBB) configured to receive an optical medium and a power-conveying medium; and
a modular ONT unit (MOU) configured to detachably couple to the base bracket, and communicate optical signals associated with the optical medium and receive power from the power medium.

2. The ONT of claim 1, wherein the MOU is further configured to communicate external format signals associated with an external environment, convert the optical signals to the external format signals, and convert the external format signal to the optical signals.

3. The ONT of claim 1, wherein the OBB includes:
a housing configured to facilitate fixed attachment to a mount, the housing including a recess configured to receive the MOU.
an optical connection configured to couple to the optical medium and a power connection configured to couple to the power-conveying medium; and,
a first connector component disposed within the recess, configured to convey the optical signals and the power to a second connector component associated with the MOU, wherein the first and second connector components are configured to removably couple to one another.

4. The ONT of claim 3, wherein the mount is a structural fixture.

5. The ONT of claim 4, wherein the structural fixture is a wall panel, and wherein the OBB attaches to the wall panel and does not attach to a structural component that supports the wall panel.

6. The ONT of claim 3, wherein the first connector component and the second connector component are configured to facilitate mechanical mating of one or more optical fibers in the first connector component with one or more corresponding optical fibers in the second connector component.

7. The ONT of claim 1, wherein the modular unit includes a main circuit module and a secondary circuit module configured to be removably coupled to one another.

8. The ONT of claim 7, wherein the main circuit module includes a first connector component to convey at least one of optical information, electrical information and power to a second connector component associated with the secondary circuit module, wherein the first and second connector components are configured to removably couple to one another.

9. The ONT of claim 7, wherein the one or more of the main circuit module and the secondary circuit module includes at least one socket for accepting a passive optical network chipset, the socket being configured to support non-permanent deployment of the passive optical network chipset.

10. The ONT of claim 1, further including one or more securing components associated with the MOU and the OBB, the securing components configured to removably secure the MOU to the OBB.

11. The ONT of claim 1, wherein the MOU includes a conversion module that performs one or more of converting the optical signals to the external format signals and converting the external format signal to the optical signals.

12. The ONT of claim 1, wherein the external format signals are Ethernet signals, and the MOU is configured to provide one or more Ethernet ports for conveying the Ethernet signals.

13. The ONT of claim 1, wherein the external format signals are video signals, and the MOU is configured to support one or more cameras that generate the video signals.

14. The ONT of claim 13, wherein the MOU includes a faceplate having a transparent dome for covering the one or more cameras.

15. An optical network terminal base bracket (OBB), comprising:
a housing configured to facilitate fixed attachment to a structural fixture, the housing including a recess configured to receive a modular optical network terminal unit (MOU);
one or more optical connections each configured to couple to the optical medium and a power connection configured to couple to the power-conveying medium; and,
a first connector component disposed within the recess, configured to convey one or more optical signals from the optical medium and power from the power-conveying medium to a second connector component associated with the MOU, wherein the first and second connector components are configured to removably couple to one another.

16. The OBB of claim 15, wherein the power connection is adapted to accept two or more power formats.

17. The OBB of claim 16, wherein the two or more power formats are selected from the group including an AC power feed, a battery pack and a dedicated centralized power feed.

18. The OBB of claim 15, further including an indicator coupled to the power terminal, the indicator configured to provide an indication that the power terminal is receiving power.

19. The OBB of claim 15, wherein the first connector is configured to provide an optical test point for an optical distribution network optically connected to the one or more optical connections.

20. The OBB of claim 15, wherein the first connector component and the second connector component further configured to facilitate mechanical mating of the optical fibers in the first connector component with the optical fibers in a second connector component.

21. The OBB of claim 15, wherein the one or more optical connections, the power connection and the first connector component form an integrated unit such that individual conducting components of the one or more optical connections and the power connection directly feed through to individual conducting components of the first connector component.

22. The OBB of claim 15, further including one or more heat sinks and one or more air vents, the one or more heat sinks being configured to convey thermal energy from one or more components of the optical network terminal to air local to the one or more air vents.

23. An optical local area network (OLAN) comprising:
two or more optical network terminal base brackets (OBBs), each being fixedly attached to a corresponding structural fixture;
each of the two or more OBBs configured to facilitate fixed attachment to a structural fixture, each OBB being configured to accept optical media and power-conveying media, and being configured to facilitate detachably coupling of a modular optical network terminal unit (MOU) to the OBB ; and
each of the at least one of the OBBs terminating at least one optical fiber medium and at least one power-conveying medium.
